(19) United States
(12) Patent Application Publication
(10) Pub. No.: US 2004/0137134 A1
(43) Pub. Date: Jul. 15, 2004

(54) Process for producing deep-fried bean curd pouch

(76) Inventors: Jiro Kanamori, Tsukuba-gun (JP); Tomohiko Adachi, Kobe-shi (JP); Hideaki Yokoyama, Kobe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/743,758

(22) Filed: Dec. 24, 2003

(30) Foreign Application Priority Data
Dec. 26, 2002 (JP) 2002-375935

(51) Int. Cl. A23L 1/36

(52) U.S. Cl. 426/629

(57) ABSTRACT

An efficient process for producing a deep-fried bean curd pouch (aburage) utilizing a soybean protein, which is characterized in that a soybean protein, a fat ingredient and water are emulsified, and then a solution of a coagulant such as magnesium chloride, calcium chloride or a bittern is added.

### BACKGROUND OF THE INVENTION

1. Field of the Invention

The present invention relates to an efficient process for producing a deep-fried bean curd pouch (aburage) utilizing a soybean protein.

2. Background of the Invention

As a method for producing a deep-fried bean curd pouch utilizing a soybean protein emulsified with a fat ingredient and water, many processes have been proposed. For example, JP 52-015844 A discloses a process wherein an emulsified material of a soybean protein substantially free from an alkaline earth metal salt is heated in an oil to obtain a deep-fried bean curd pouch. In JP 57-138354 A, a deep-fried bean curd pouch is obtained by heating a molded mixture of two kinds of emulsified materials in an oil, one of which contains a mixture obtained by mixing an acidic soybean protein isolate and an alkaline agent containing an alkaline earth metal salt in a solid state, and a fat ingredient. JP 61-173760 A discloses frying of a molded material containing a non-dried material of acid precipitated soybean protein curd dissolved by adding an alkaline agent containing an alkaline earth metal hydroxide, and a fat ingredient to obtain a deep-fried bean curd pouch. In JP 9-065848 A, a deep-fried bean curd pouch is produced by frying a molded material which is obtained by homogenizing a mixture prepared by adding a soybean protein powder and a coagulant to curd obtained by heating a soybean protein solution or emulsion and adding a coagulant. However, in these processes, extension of products tend to be deteriorated with time after preparation of dough materials to be fried and they are quite different from the desirable efficient process that the present inventors are seeking.

### SUMMARY OF THE INVENTION

An object of the present invention is to provide an efficient process for producing a deep-fried bean curd pouch utilizing a soybean protein.

Thus, the present invention provides a process for producing a deep-fried bean curd pouch which comprises emulsifying a soybean protein, a fat ingredient and water, followed by addition of a solution of a coagulant. Preferably, the coagulant is a rapidly acting coagulant such as magnesium chloride, calcium chloride or a bittern.

Further, the present invention provides the deep-fried bean curd pouch produced by the process of the present invention.

According to the present invention, even when a dough material whose main raw materials are a soybean protein, a fat ingredient and water is allowed to stand for a long period of time after preparation thereof and before heating in an oil, extension of the product is not deteriorated and a deep-fried bean curd pouch having good extension can be stably and efficiently produced.

### DETAILED DESCRIPTION OF THE PREFERRED EMBODIMENTS

Hereinafter, the present invention will be illustrated in detail.

The present invention provides an efficient process for preparing a deep-fried bean curd pouch utilizing a soybean protein and characterized in that a solution of a coagulant is added after emulsifying a soybean protein, a fat ingredient and water. The process of the present invention is quite different from a process wherein a deep-fried bean curd pouch is produced by using soybean milk extracted from whole soybeans, and is performed by simple operations. In addition, dehydrated whey is not formed in the process of the present invention. Further, better extension and shape of the product are obtained as compared with a case where a coagulant in the form of a solution is not used.

More specifically, since there is no established industrial continuous emulsifying technique for mixing raw materials such as a soybean protein, a fat ingredient, water, etc. to prepare a dough material for a deep-fried bean curd pouch, a batch-wise kneading and emulsifying machine such as a silent cutter, Stephen cutter, etc. is used. The dough material thus prepared becomes gradually hard with time. This phenomenon is referred to as “suwari (elasticity)” and, when a dough material which has caused “suwari” is heated in an oil, the resultant product tends to have poor extension. If a kneading and emulsifying machine used in the production of a deep-fried bean curd pouch is a batch-wise one, a dough material prepared by a previous batch is allowed to stand for about 10 to 30 minutes, until a dough material of a next batch is prepared. “Suwari” is caused during this standing and products having different extension are resulted depending upon respective batches. Such a process lacks stability, and is undesirable in view of supplying a product of constant quality.

The present inventors have studied intensively to establish a stable and efficient process. Thus, the present invention has been completed. The process for producing a deep-fried bean curd pouch of the present invention can be performed by conventional operations except the operations illustrated hereinafter.

Examples of the soybean protein used in the present invention include a soybean protein isolate, a soybean protein concentrate, etc., with a soybean protein isolate being preferred.

The fat ingredient is not specifically limited, and animal and vegetable fats and oils such as soybean oil, rapeseed oil, palm oil, coconut oil, lard, beef tallow, etc., may be used.

Other additives such as “okara (soy pulp)” and flavoring agents, e.g., table salt, sugar, etc., may be added, if necessary. Further, in addition to the soybean protein, the fat ingredient and water, starch may be added to adjust mouthfeel.

Water is added at the time of preparing a dough material and it is preferred to add water so that the dough material contains 54 to 18 parts by weight of the soybean protein and 60 to 11 parts by weight of the fat ingredient based on 100 parts of water. When the amount of water is too much, the dough material prepared is too soft to mold it. On the other hand, when the amount of water is too small, a dough material is hardly prepared. If desired, soy milk may be used instead of a part of water.

For an emulsifying machine, silent cutter, Stephen cutter, etc., is preferred because of high emulsifying efficacy. The coagulant should be added after completion of emulsification of a dough material. In the present invention, an acceptable period of time for allowing to stand the dough material prepared is not specifically limited. Even if the dough material is allowed to stand for about 10 to 60 minutes after preparation, stable extensibility can be obtained without inhibition of extensibility of the dough material during heating in an oil. However, allowing to stand the dough material for a too long period of time should be avoided because the dough material is dried out.

The coagulant is that used for producing tofu (soybean curd). In general, alkaline earth metal salts, in particular, calcium salts and magnesium salts are used. Preferred examples thereof include calcium chloride, calcium sulfate, magnesium chloride, a bittern, etc. Alternatively, a coagulant such as glucono delta lactone which causes coagulation by acidification due to gluconic acid formed by dissolution of the coagulant in water may also be used. In the present invention, a coagulant of high water-solubility and high reactivity, i.e., a rapidly acting coagulant such as calcium chloride, magnesium chloride or a bittern is more preferred. If a coagulant of low reactivity, or a slowly acting coagulant is used, its reaction progresses slowly and “suwari” may occur in the dough material, thereby deteriorating extensibility of the dough material. The amount of the coagulant added is preferably from 0.5% by weight to 5% by weight, more preferably from 1% by weight to 3% by weight based on the soybean protein. When the amount of the coagulant is too small, extension is deteriorated on the whole. When the amount of the coagulant is too much, extension is also deteriorated.

After addition of the coagulant, the dough material is kneaded to such an extent that emulsification is not broken, in particular, for a short period of time such as from 30 seconds to 2 minutes, and then molded into a desired size by a molding machine, and heated in an oil (frying). Frying is performed according to a known method for producing deep-fried bean curd pouches. In general, multi-step frying such as two-step or three-step frying is performed. Three-step frying is preferred, and more preferably, for example, the first-step is performed at not lower than 60° C. and lower than 100° C., the second-step is performed at not lower than 100° C. and lower than 150° C., and the third-step is performed at 150° C. to 200° C. Alternatively, two-step and three-step frying may be performed with continuously elevating the oil temperature with temperature gradient.

“Extensibility” or “extension” herein can be indicated by the size of the deep-fried bean curd pouch obtained by frying the dough material having a given size, and, for example, can be expressed by an average value (mm) of longitudinal or crosswise direction of the deep-fried bean curd pouch measured with a slide gauge.

The fundamental concept of the present invention is that, after sufficiently emulsifying the soybean protein without the coagulant, the soybean protein is rapidly reacted with the highly reactive coagulant and the reaction is rapidly terminated, thereby the desired stability can be achieved.

The following Examples, Comparative Examples and Reference Examples further illustrate the present invention in detail but are not to be construed to limit the scope of the present invention. All the parts are by weight unless otherwise stated.

### EXAMPLE 1

Soybean protein isolate (1000 parts, “FUJIPRO E” manufactured by FUJI OIL CO., LTD.), rapeseed oil (300 parts), water (3000 parts), corn starch (50 parts), and table salt (10 parts) were kneaded and emulsified for 3 minutes by using a silent cutter (manufactured by Bibun K.K.), and then, magnesium chloride (15 parts) dissolved in water (30 parts) was added thereto. Kneading was performed for additional 1 minute. The resultant dough material was allowed to stand for 10 minutes or 20 minutes, and then molded into 45 mm square and 7 mm thickness by using a molding machine (manufactured by MURAKAMI M.F.G.Co.,LTD.). The molded dough material was fried in a three-step fryer using a 77 mm square mold form (at 70° C. for 4 minutes, at 110° C. for 2 minutes, and at 170° C. for 4 minutes) to obtain a deep-fried bean curd pouch.

### COMPARATIVE EXAMPLE 1

According to the same manner as that in Example 1, a deep-fried bean curd pouch was produced except that 15 parts of slowly acting calcium sulfate (15 parts) was dissolved in water (3030 parts) and kneaded and emulsified with the soybean protein isolate and rapeseed oil instead of addition of magnesium chloride (15 parts) dissolved in water (30 parts).

### COMPARATIVE EXAMPLE 2

According to the same manner as that in Example 1, a deep-fried bean curd pouch was produced except that soybean protein isolate neutralize with calcium hydroxide was used and the amount of water was 3030 parts instead of addition of magnesium chloride (15 parts) dissolved in water (30 parts).

### REFERENCE EXAMPLE 1

According to the same manner as that in Example 1, a deep-fried bean curd pouch was produced except that the amount of magnesium chloride was 1 part.

### REFERENCE EXAMPLE 2

According to the same manner as that in Example 1, a deep-fried bean curd pouch was produced except that magnesium chloride (60 parts) was dissolved in water (120 parts).

TABLE 1
Results of quality evaluation

| | | Compar- | Compar- | Refer- | Refer- |
|---|---|---|---|---|---|
| | | ative | ative | ence | ence |
| | Example | Example | Example | Example | Example |
| Item | 1 | 1 | 2 | 1 | 2 |
| Size (mm) | 77 | 77 | 55 | 60 | 65 |
| (standing | | | | | |
| dough | | | | | |
| material | | | | | |
| for 10 | | | | | |
| minutes) | | | | | |
| Size (mm) | 77 | 65 | 55 | 57 | 63 |
| (standing | | | | | |
| dough | | | | | |
| material | | | | | |
| for 20 | | | | | |
| minutes) | | | | | |

* Acceptable range of size was from 72 mm to 77 mm by an average value of 10 products.

In Example 1, the coagulant was added in an amount 1.5% by weight based on the soybean protein, the product had good extensibility and was within the acceptable range of size. In Comparative Example 1, the coagulant was added before emulsification of the soybean protein and extensibility after standing the dough material for 10 minutes was good, but that after standing the dough material for 20 minutes was poor. Then, the product did not satisfy the acceptable range of size. When calcium sulfate in Comparative Example 1 was replaced to the same magnesium chloride having high reactivity as that in Example 1, even the dough material after standing for 10 minutes did not have extensibility within the acceptable range of size. It is considered that this is because of using a slowly acting coagulant. Similarly, in case of adding calcium sulfate after emulsification of the soybean protein, the dough material had poor extensibility.

In Comparative Example 2, Reference Examples 1 and 2, the dough materials had poor extensibility and the products did not satisfy the acceptable range of size. Comparative Example 2 represents the case that calcium component has been added to the soybean protein in advance, showing that poor extensibility is due to unsuccessful emulsification. Reference Examples 1 and 2 represents the effect of the amount of magnesium chloride. Even when the amount of magnesium chloride was increased from 1 part (0.1% by weight based on the soybean protein) in Reference Example 1 to 60 parts (6% by weight based on the soybean protein) in Reference Example 2, but the size was not within the acceptable range of size.

What is claimed is:

1. A process for producing a deep-fried bean curd pouch which comprises emulsifying a soybean protein, a fat ingredient and water, followed by addition of a solution of a coagulant.

2 The process according to claim 1, wherein the coagulant is a rapidly acting coagulant.

3 The process according to claim 1, wherein the coagulant is magnesium chloride, calcium chloride or a bittern.

4 The process according to claim 1, wherein the coagulant is added in an amount of 0.5 to 5% by weight based on the soybean protein.

5 The deep-fried bean curd pouch produced by the process according to claim 1.
